(19) United States
(12) Patent Application Publication
(10) Pub. No.: US 2025/0187711 A1
(43) Pub. Date: Jun. 12, 2025

(54) PROPULSION SYSTEM

(71) Applicant: VOLVO PENTA CORPORATION, Göteborg (SE)

(72) Inventor: Lars LARSSON, Alingsås (SE)

(73) Assignee: VOLVO PENTA CORPORATION, Göteborg (SE)

(21) Appl. No.: 18/962,998

(22) Filed: Nov. 27, 2024

(30) Foreign Application Priority Data
Dec. 6, 2023 (EP) 23214664.7

(51) Int. Cl. B63H 20/10; F15B 15/26

(52) U.S. Cl. CPC B63H 20/106; F15B 15/26; F15B 2015/268

(57) ABSTRACT

A propulsion system for a marine vessel has a transom bracket to be connected with a transom of the marine vessel. A drive unit is rotatably connected with the transom bracket so as to be pivotable from a lowered position into a raised position, or vice versa, around a pivot joint. An actuator is configured to move the drive unit around the pivot joint, wherein a brake device is arranged in connection with the pivot joint. The brake device is configured to maintain the drive unit in position independently of a state of the actuator.

### TECHNICAL FIELD

The disclosure relates generally to a propulsion system. In particular aspects, the disclosure relates to a marine propulsion system for a marine vessel. The disclosure can be applied to marine vessels, such as water crafts, motorboats, work boats, sport vessels, boats, ships, among other vessel types. Although the disclosure may be described with respect to a particular marine vessel, the disclosure is not restricted to any particular marine vessel.

### BACKGROUND

Propulsion systems for marine vessels are known. These propulsions systems having a drive unit which may be trimmed so as to improve the marine vessel's performance and energy consumption to power the drive unit. In addition, the drive units may also be up-tilted, i.e. raised out of the water when the marine vessel is in the harbour so that, for instance, the risk for fouling on the drive unit and propellers are minimised.

However, sometimes the drive unit may be unintendedly lowered, for instance when a pressure drop occurs after a period of time in the up-tilted position. Although many prior art solutions function satisfactorily with mechanical locking of the drive unit, there is still room for improvement in terms of for example design, control and reliability during different storage and up-tilted modes of the drive unit.

### SUMMARY

According to a first aspect of the disclosure, a propulsion system for a marine vessel, comprising
a transom bracket being configured to be connected with a transom of the marine vessel, a drive unit being rotatably connected with the transom bracket so as to be pivotable from a lowered position into a raised position, or vice versa, around a pivot joint,
an actuator being a configured to move the drive unit around the pivot joint,
wherein a brake device is arranged in connection with the pivot joint, the brake device is configured to maintain the drive unit in position independently of a state of the actuator. The first aspect of the disclosure may seek to solve the disadvantages with the prior solutions where the drive unit is placed in an up-tilted position where it may intended or unintended loose its position. A technical benefit may include that the brake device is configured to maintain the drive unit in position independently of a state of the actuator. Hence, if the actuator is unable of maintain the position of the drive unit for some reason the brake device is configured to do this. In addition, by arranging the brake device in connection with the pivot joint a more compact system is obtained.

Optionally in some examples, including in at least one preferred example, further comprising a hydraulic unit and/or a pneumatic unit providing pressure to the actuator and/or to the brake device. A technical benefit may include that both the actuator and/or the brake device may be pressurized by hydraulic or pneumatic.

Optionally in some examples, including in at least one preferred example, the brake device is configured to maintain the drive unit in position independently of variations of a pressure of the actuator. A technical benefit may include that where the actuator is pressurized by hydraulic and the actuator has up-tilted the drive unit, in for instance a storage position, it may occur that a pressure drop in the hydraulic system takes place. When the pressure drop takes place, the drive unit will not be maintained in position wherefore it may be lowered unintendedly. In this circumstance the brake device ensures that the drive unit is maintained independently of the pressure of the actuator.

Optionally in some examples, including in at least one preferred example, the brake device comprises a cone brake unit. A technical benefit may include that the cone brake unit may be arranged in connection with the pivot joint and that it does not take up much space.

Optionally in some examples, including in at least one preferred example, the cone brake unit comprises a cone brake face having a friction enhanced surface or coating. A technical benefit may include that it is a friction brake between two faces instead of a mechanical lock.

Optionally in some examples, including in at least one preferred example, the cone brake unit comprises a plurality of compression springs arranged around the cone. A technical benefit may include that the brake device is compact yet reliable.

Optionally in some examples, including in at least one preferred example, the plurality of compression springs are configured to provide a predetermined spring force so that the cone brake face is pushed against another face when a pressure drop occurs and/or when the pressure is below a predetermined pressure. A technical benefit may include that when the hydraulic pressure or pneumatic pressure falls below the spring force of the compression springs, the compression springs will press the cone brake face against an opposite face whereby the drive unit maintains its position by friction between the two faces.

Optionally in some examples, including in at least one preferred example, the compression springs in a first end abut a circumferential wall, on the opposite side of the circumferential wall a circumferential space is arranged, the circumferential space is in fluid connection with the hydraulic unit. A technical benefit may include that the brake device may be activated independently of any pressure and any state of the actuator as well as it may be deactivated by pressurizing the space so that the hydraulic pressure exceed the spring force.

Optionally in some examples, including in at least one preferred example, a valve is arranged between the space and the hydraulic unit. A technical benefit may include that hydraulic pressure to the space may be controlled independently of any other pressure and/or pressure drop other places in the hydraulic unit.

Optionally in some examples, including in at least one preferred example, further comprising a control unit being configured to control the hydraulic unit. A technical benefit may include that the control unit is configured to control the hydraulic pressure supplied to the space of the cone brake unit.

Optionally in some examples, including in at least one preferred example, the drive unit has a transportation function, wherein the brake device is activated. A technical benefit may include in a circumstance where the marine vessel is being transported by a trailer and the drive unit is up-tilted for avoiding it may hit the ground, the brake device ensures that it will maintain in position even in circumstances where the trailer is bumping or during an abrupt braking.

Optionally in some examples, including in at least one preferred example, the actuator is a linear actuator or a rotational actuator. A technical benefit may include that independent of which actuator is chosen for the drive unit the brake device may function.

Optionally in some examples, including in at least one preferred example, the drive unit is connected with the transom bracket via a connecting arm having the pivot joint connected with the transom bracket and an additional pivot joint connected with the drive unit, wherein the drive unit is configured to be moved in the water and out of the water by the connecting arm pivots around the pivot joint or the drive unit pivots around the additional pivot joint or the connecting arm and the drive unit pivot around both pivot joints, wherein the pivot joint is a first pivot joint and the additional pivot joint is a second pivot joint. A technical benefit may include that the drive unit may be trimmed in different trim positions of the drive unit independently water depth. Additionally, the drive unit may be moved up and down as well as translated rearwards compared to the transom bracket while maintaining an improved angle of thrust. The disclosure can be used with advantage if a reduced draft is desired, such as when maneuvering in shallow waters close to a beach.

Optionally in some examples, including in at least one preferred example, a second brake device is arranged in connection with the second pivot joint. A technical benefit may include that both pivot joints may be braked and maintained in position independently of the state of the actuators.

According to a second aspect of the disclosure, marine vessel comprising a transom and a propulsion system as described above. The second aspect of the disclosure may seek to solve the disadvantages with the prior solutions where the drive unit is placed in an up-tilted position where it may intended or unintended loose its position. A technical benefit may include that the brake device is configured to maintain the drive unit in position independently of a state of the actuator. Hence, if the actuator is unable of maintaining the position of the drive unit for some reason the brake device is configured to do this. In addition, by arranging the brake device in connection with the pivot joint a more compact system is obtained.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary propulsion system according to an example.

FIG. 2 is an exemplary brake device according to an example.

FIG. 3 is the brake device of FIG. 2 mounted in the pivot joint.

FIG. 4 is another view of the brake device of FIG. 2.

FIG. 5 is an enlarged view of a part of the brake device of FIG. 4.

FIGS. 6-7 show in a side view the drive unit being translated rearwards according to an example.

FIGS. 8-10 show in a side view different trim of the drive unit according to an example.

FIGS. 11-14 show different view of an example of a connecting arm according to an example.

FIGS. 15-16 show different view of another example of a connecting arm according to an example.

FIGS. 17-18 show different view of another example of a connecting arm according to an example.

FIG. 19 shows a view of another example of a connecting arm according to an example.

FIG. 20 is an exemplary propulsion system according to an example.

### DETAILED DESCRIPTION

The detailed description set forth below provides information and examples of the disclosed technology with sufficient detail to enable those skilled in the art to practice the disclosure.

The prior solutions have the disadvantages when the drive unit is placed in an up-tilted position where it may intended or unintended loose its position, for instance due to a pressure drop or pressure lost. According to the present disclosure, this is solved by adding a brake device in connection with the pivot joint. The brake device is configured to maintain the drive unit in position independently of a state of the actuator. Hence, if the actuator is unable of maintaining the position of the drive unit for some reason the brake device is configured to do this. In addition, by arranging the brake device in connection with the pivot joint a more compact system is obtained compared to prior solutions.

FIG. 1 is an exemplary propulsion system 1 according to an example. The propulsion system 1 for a marine vessel 100, comprising a transom bracket 2 being configured to be connected with a transom 101 of the marine vessel 100. The propulsion system 1 also comprises a drive unit 3 being rotatably connected with the transom bracket 2 so as to be pivotable from a lowered position into a raised position, or vice versa, around a pivot joint 5. An actuator 7 is arranged and being a configured to move the drive unit 3 around the pivot joint 5. Furthermore, a brake device 50 is arranged in connection with the pivot joint 5, the brake device 50 is configured to maintain the drive unit 3 in position independently of a state of the actuator 7. The brake device 50 is indicated as a dotted circle in FIG. 1 since it is housed within a cover for protecting the brake device against the maritime environment.

The propulsion system 1 further comprises a hydraulic unit 51 and/or a pneumatic unit providing pressure to the actuator 7 and/or to the brake device 50. In the example shown in FIG. 1 the hydraulic unit 51 is arranged on the marine vessel 100 but in other examples it may be arranged in the drive unit. The brake device 50 may be configured to maintain the drive unit 3 in position independently of variations of a pressure of the actuator 7. Furthermore, the brake device 50 may also be configured to maintain the drive unit 3 in position independently of variations of a pressure of the brake device 50. The hydraulic unit 51 is configured to provide a predetermined pressure. The predetermined pressure may be the pressure necessary for moving the drive unit 3 around the pivot joint 5 and maintaining it position. As previously mentioned when the drive unit is positioned in a parked or storage position where it is up-tilted, a pressure drop may occur, having the consequence that the drive unit 3 may be lowered unintendedly. In such a circumstance, the brake device 50 is configured to lock the pivot joint 5 if the pressure of the actuator 7 is below the predetermined pressure. The same applies if a pressure drop occur in connection with the brake device 50. Moreover, the brake device 50 may be configured to unlock the pivot joint 5 when the pressure of the actuator 7 reach the predetermined pressure again, or if a pressure is applied to the brake device 50.

Furthermore, a valve 52 may be arranged between the hydraulic unit 51 and the brake device 50. The valve 52 may be controllable. The propulsion system 1 may also comprise a control unit 53 being configured to control the hydraulic unit 51. The control unit 53 is operatively connected with the valve 52. Moreover, a pressure sensor 54 may configured to measure a pressure in the hydraulic unit 51. The pressure sensor 54 may be operatively connected with the control unit 53. The brake device 50 may be configured to be self-controllable and/or is controllable.

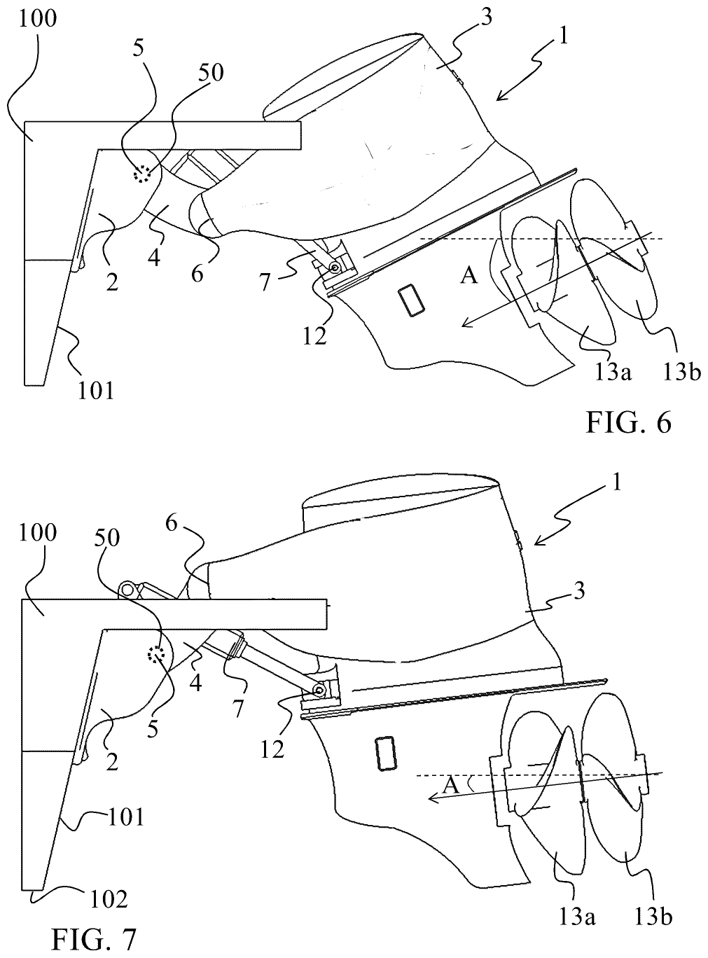

In the present example the propulsion system 1 also comprises a connecting arm 4, which will be described further in relation with FIG. 6.

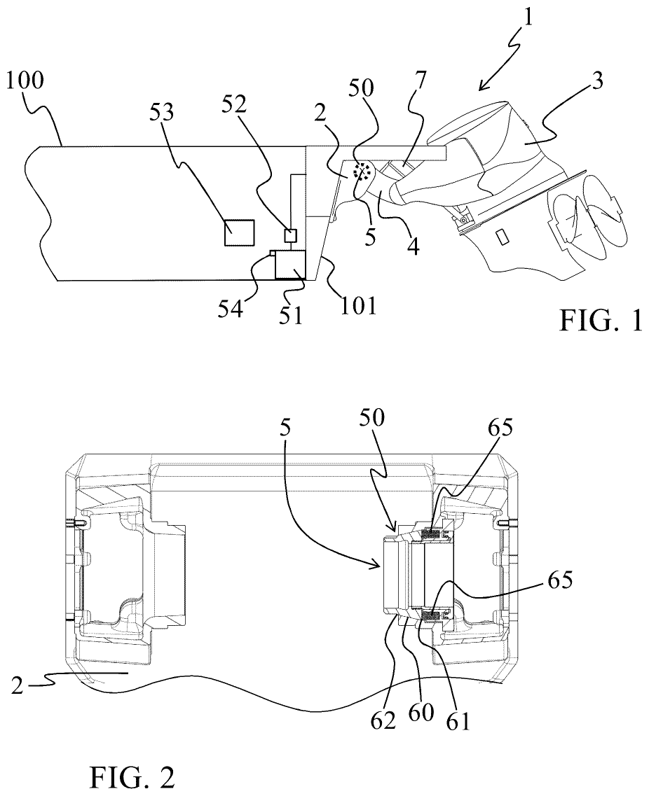

In FIG. 2, an example of the brake device 50 is shown. In the example the brake device 50 comprises a cone brake unit 50. The cone brake unit 50 is arranged in connection with the pivot joint 5 whereby a compact design of the drive unit 3 may be obtained. The cone brake unit 50 has the form as a hollow cone and comprises a cone brake face 60. In the present example the cone brake face 60 is arranged on an exterior face of the cone brake unit 50. The cone brake face 60 tapers from a first brake end 61 towards a second brake end 62. The cone brake face 60 may have a friction enhanced surface or coating applied to the cone brake face. The cone brake unit 50 may be connected with the transom bracket 2.

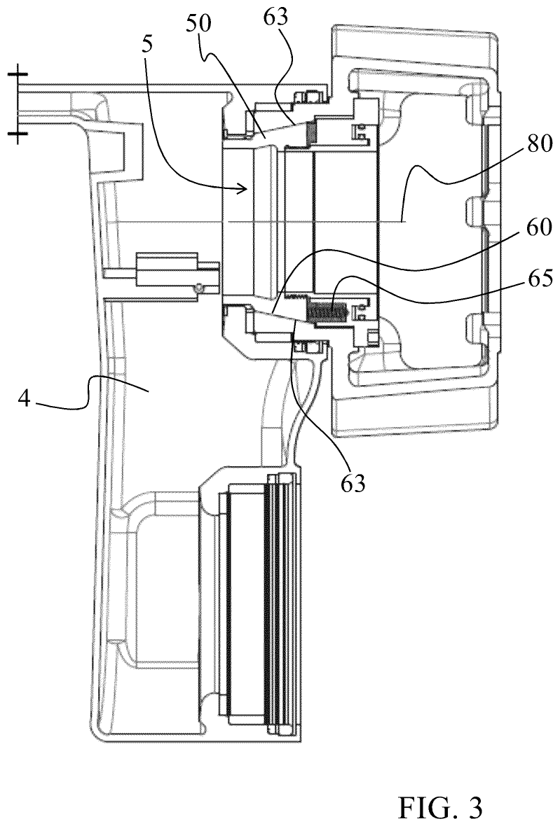

In FIG. 3, the cone brake unit 50 is mounted at the pivot joint 5. The cone brake unit 50 comprises a plurality of compression springs 65 arranged around the conc. The plurality of compression springs 65 are configured to provide a predetermined spring force so that the cone brake face 60 is pushed against another face 63 when a pressure drop occurs and/or when the pressure is below a predetermined pressure. In addition, the plurality of compression springs 65 may be evenly distributed around the circumference of the cone so that an even spring force may be provided around the circumference so that an enhanced friction may be achieved when the springs are pushing the brake cone face 60 against another face 63. The another face 63 is also tapering so that when the compression springs apply their spring force the cone brake face 60 is pushed against the other face 63 so that a friction locking between the two faces 60, 63 are obtained. The friction locking may function as a clutch. Furthermore, the another face 63 may also have a friction enhanced surface or coating.

The cone brake unit 50 is hollow. Furthermore, the cone brake unit 50 and the pivot joint 5 have a common center axis 80. The cone brake unit 50 and the pivot joint 5 are hollow along the common center axis 80 as seen in FIG. 3. Hereby, harnesses, rigging, cables and/or wires may be configured to be guided through the hollow pivot joint 5 and cone brake unit 50 from the marine vessel 100 to the drive unit 3 and vice versa.

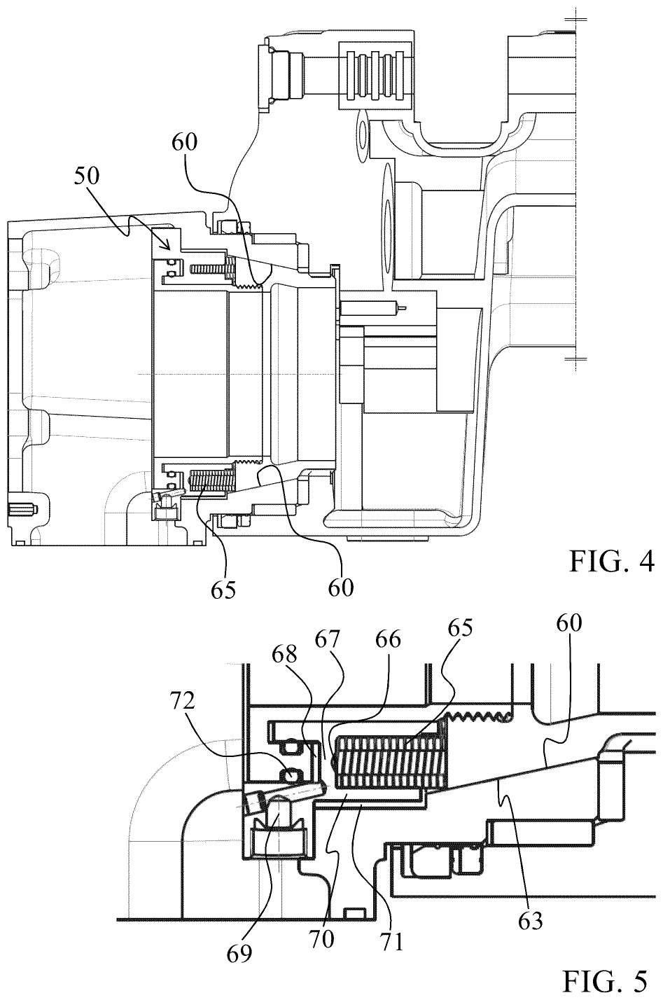

FIG. 4 shows the cone brake unit 50 is another cross-sectional view. In FIG. 5, an enlarged view of a part of the cone brake unit 50 of FIG. 4 is shown in a cross-sectional view. The compression springs 65 in a first spring end 66 abut a circumferential wall 67, on the opposite side of the circumferential wall 67 a circumferential space 68 is arranged. The circumferential space 68 is in fluid connection with the hydraulic unit via channel 69. The compression springs 65 are arranged in a pressure element 70 which is movable within the cavity 71. Sealings 72 are arranged for avoiding that the hydraulic is leaking unintendedly.

In the circumstance where the drive unit 3 has a raised position, i.e. an up-tilted position, being for instance a storage or parked position, the brake device may be activated for ensuring that the drive unit not unintendedly lowers.

Furthermore, the drive unit 3 also have a transportation function, wherein the brake device 50 may be activated at lower pressure. The transportation function is for instance where the marine vessel 100 is being transported on a trailer and the drive unit 3 is up-tilted for avoiding it may hit the ground. The brake device 50 ensures that it will maintain in position even in circumstances, where the trailer is bumping or during an abrupt braking. The brake unit 50 function with friction locking between two abutting faces which additionally ensures, that the brake unit and the drive unit is more protected, due to possible slip from overload between two faces, during possible bump or brake compared to known solutions, having a mechanically locking of the drive unit.

FIG. 6 is an exemplary view of the propulsion system 1 for a marine vessel 100 according to an example. The propulsion system 1 comprises the transom bracket 2 configured to be connected with the transom 101 of the marine vessel 100, and the drive unit 3. The drive unit 3 is arranged to be moved in relation to the transom bracket 2 for moving the drive unit 3 in the water and out of the water. The drive unit 3 is connected with the transom bracket 2 via the connecting arm 4 having the first pivot joint 5 connected with the transom bracket 2 and a second pivot joint 6 connected with the drive unit 3. The drive unit 3 is configured to be moved in the water and out of the water by the connecting arm 4 pivots around the first pivot joint 5 or the drive unit 3 pivots around the second pivot joint 6 or the connecting arm 4 and the drive unit 3 pivot around both pivot joints 5, 6. According to the disclosure, a brake device 50 is arranged in connection with the first pivot joint 5. However, a second brake device may also be arranged in connection with the second pivot joint 6.

In FIG. 6, the drive unit 3 has been moved rearwards while it has been tilted up by rotating the connecting arm 4 around the first pivot joint 5. In addition, the drive unit 3 has been rotated around the second pivot joint 6 of the connecting arm 4 so that a positive trim angle A is obtained of the drive unit 3.

The drive unit 3 is configured to be moved by the connecting arm 4 is pivoted around the first pivot joint 5 in a clockwise direction or an anticlockwise direction independently of any pivoting of the drive unit around the second pivot joint 6. In FIG. 6, the connecting arm 4 has been pivoted in an anticlockwise direction around the first pivot joint 5.

In addition, the drive unit 3 is configured to be moved by the drive unit is pivoted around the second pivot joint 6 in a clockwise direction or an anticlockwise direction independently of any pivoting of the connecting arm 4 around the first pivot joint 5. In FIG. 6, the drive unit 3 has been pivoted in an anticlockwise direction around the second pivot joint 6.

The drive unit 3 is configured to be moved by the connecting arm 4 is pivoted around the first pivot joint 5 in a clockwise direction or an anticlockwise direction at the same time as the drive unit 3 is pivoted around the second pivot joint 6 in a clockwise direction or an anticlockwise direction. In FIG. 6, the connecting arm 4 has pivoted in an anticlockwise direction around the first pivot joint 5 and the drive unit 3 has been pivoted in an anticlockwise direction around the second pivot joint 6. Hence, the drive unit 3 may be trimmed in different trim positions by pivoting the drive unit 3 around the second pivot joint 6 and the position in the water of the drive unit may at the same time been obtained by pivoting the connecting arm 4 around the first pivot joint 5. Freedom to position the drive unit 3 in relation the transom bracket 2 is obtained. Additionally, the drive unit 3 may be moved up and down as well as translated rearwards in relation to the transom bracket 2 while maintaining an improved angle of thrust A.

In an example, the drive unit 3 comprises one or more propellers. In FIG. 6, the drive unit 3 comprises a first propeller 13a and a second propeller 13b. In the example, the first propeller 13a and the second propeller 13b are configured to push the marine vessel 100 in a forward motion of the marine vessel 100. In another example the one or more propellers are configured to pull the marine vessel 100 in a forward motion of the marine vessel.

In FIG. 6, the first propeller 13a and second propeller 13b have an angle of thrust A, indicated by the angle between the dotted line and the arrow in FIG. 6. The drive unit 3 has been pivoted in the anticlockwise direction around the second pivot joint 6 so that a positive trim angle and thereby angle of thrust A for the first propeller 13a and the second propeller 13b. In an example, the first propeller 13a is arranged to be counter-rotating compared to the second propeller 13b.

In FIG. 6, a linear actuator 7 is arranged between the connecting arm 4 and the drive unit 3. The linear actuator 7 is configured to pivot the drive unit 3 around the second pivot joint 6 in either the clockwise direction or the anticlockwise direction and thereby a trim angle of the drive unit 3 and the angle of thrust may be set in relation to the circumstance. The linear actuator 7 is connected with the drive unit 3 in a distance below the second pivot joint 6 and is connected with the drive unit 3 via a drive pivot joint 12 so that it is ensured that the linear actuator 7 transfer force to pivot the drive unit 3 around the second pivot joint 6.

In FIG. 7, the drive unit 3 has been tilted further up by rotating the connecting arm 4 around the first pivot joint 5 compared to in FIG. 6. In addition, the drive unit 3 has been rotated in anticlockwise direction around the second pivot joint 6 of the connecting arm 4 so that an improved angle of thrust A of the first propeller 13a and the second propeller 13b is obtained even though the drive unit 3 has been raised to a position being higher than a bottom 102 of the marine vessel 100. Hereby the drive unit 3 may be trimmed to an optimum position irrespective of the sailing in shallow waters since the bottom 102 of the marine vessel 100 is protecting the drive unit 3 and its propellers against impact.

Compared to FIG. 6, the connecting arm 4 in FIG. 7 has been pivoted further around the first pivot joint 5 in an anticlockwise direction thereby tilting the drive unit 3 upwards. The connecting arm 4 is configured to be pivoted around the first pivot point 5 in maximum 200 degrees, preferably maximum 180 degrees.

In addition, the drive unit 3 may also be positioned so that it is raised out of the water in a parked position, when not in use, for instance when the marine vessel 100 is in the harbour or at the beach. In this circumstance the braking device 50 according to the disclosure may be activated so that the drive unit 3 may be maintained in the raised position independently of the state of the actuator 7, for instance if a pressure drop occurs.

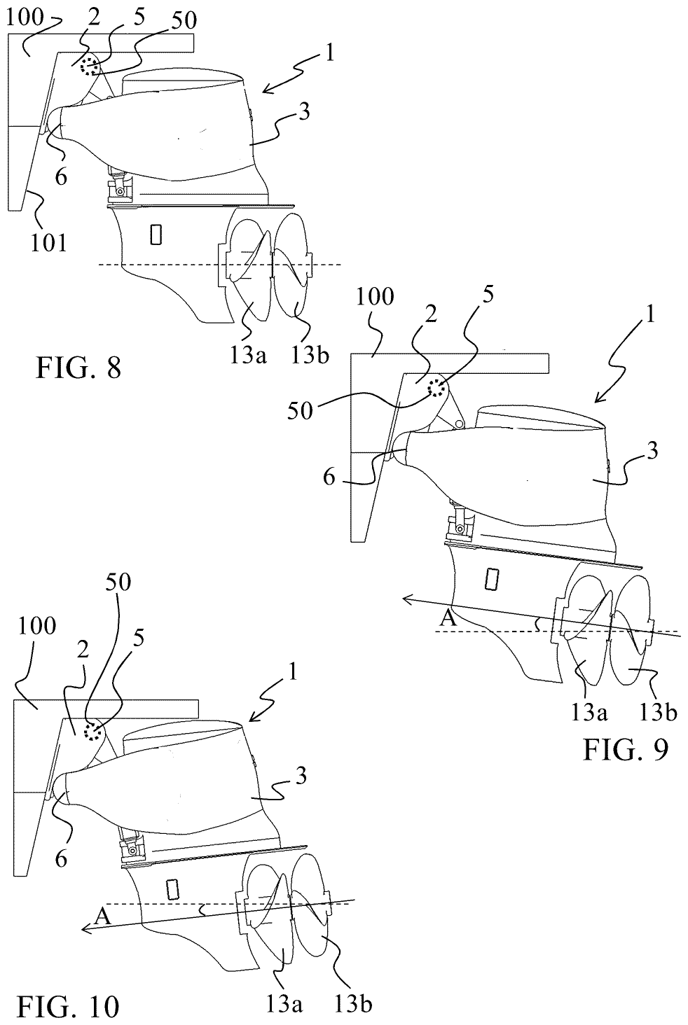

In FIG. 8, the drive unit 3 is positioned in neutral trim. The drive unit 3 is positioned in its low position where the connecting arm has been pivoted around the first pivot joint 5 in a clockwise direction. In addition, the drive unit 3 has been pivoted around the second pivot joint 6 of the connecting arm so as to be in a neutral trim where the angle of thrust of the first propeller 13a and the second propeller 13b are zero.

In FIG. 9, the drive unit 3 has been pivoted in a clockwise direction around the second pivot joint 6 so as to position the drive unit 3 in a negative trim having a negative angle of thrust A of the first propeller 13a and the second propeller 13b. The connecting arm has in FIG. 9 not been pivoted around the first pivot joint 5. Hence, the drive unit 3 has been trimmed but not tilted.

In FIG. 10, the drive unit 3 has been pivoted in an anticlockwise direction around the second pivot joint 6 so as to position the drive unit 3 in a positive trim having a positive angle of thrust A of the first propeller 13a and the second propeller 13b. The connecting arm has in FIG. 10 not been pivoted around the first pivot joint 5. Hence, the drive unit 3 has been trimmed but not tilted.

By the disclosure it is obtained that the drive unit 3 may be positioned freely in relation to the transom bracket 2 both in rotation but also vertical movements as well as horizontal movements.

The rotation of the connecting arm 4 around the first pivot joint 5, and the rotation of the drive unit 3 around the second pivot joint 6 may be provided different ways.

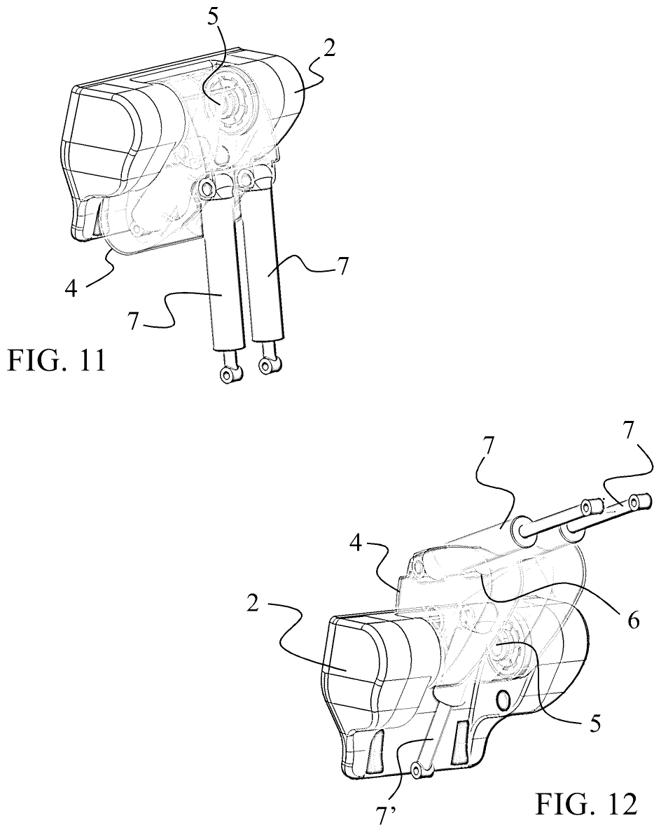

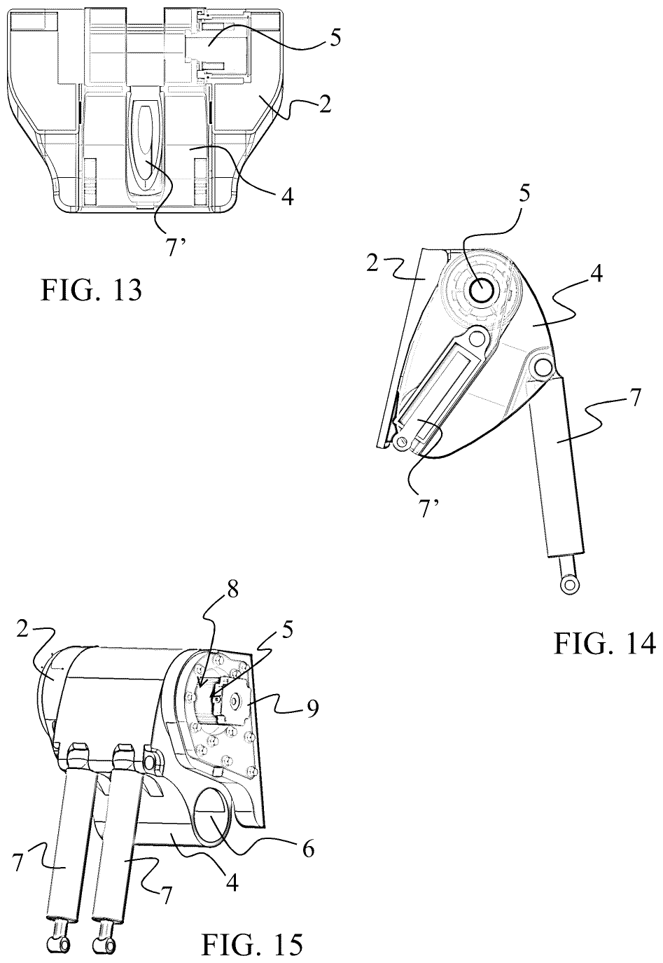

In FIGS. 11-14 an example is shown, where a number of linear actuators 7 are arranged. Two linear actuators 7 are arranged adjacent to each other and are connected with the connecting arm 4 at one end and is configured to be connected with the drive unit in the opposite end. The linear actuators 7 may be hydraulic cylinders. The linear actuators 7 are arranged to pivot the drive unit around the second pivot joint 6 by extracting the cylinders or retracting the cylinders. In FIG. 11, the connecting arm 4 is not pivoted around the first pivot joint 5 whereby the connecting arm 4 is positioned along the transom bracket 2. In FIG. 12, the connecting arm 4 has been pivoted in an anticlockwise direction around the first pivot joint 5 whereby the connecting arm 4 is projecting from the transom bracket 2. In the example, an additional linear actuator 7′ is connected with the connecting arm 4 at one end and at the opposite end to the transom bracket 2. The linear actuator 7′ is arranged to pivot the connecting arm 4 around the first pivot joint 5 by extracting the cylinder or retracting the cylinder. In FIG. 12, the cylinder has been extracted so that the connecting arm 4 is rotated in the anticlockwise direction. The additional linear actuator 7′ is assisting in raising and lowering the connecting arm 4 and thereby the drive unit. In FIG. 13, is shown that the connecting arm 4 may have two parts spaced apart so that the additional linear actuator 7′ may be arranged in the space between the two parts. Hereby a compact design of the connecting arm 4 and the transom bracket 2 is obtained. As shown in FIG. 13, the first pivot joint 5 may be hollow. In FIG. 14, the example is shown in a side view. The linear actuators 7 may be longer than the additional linear actuator 7′. The hydraulic unit 51 may be arranged for powering the linear actuator(s). The hydraulic unit 51 may be arranged in the drive unit 3 or at the marine vessel 100.

In another example, a rotation motor may be arranged in connection with the first pivot joint. The rotation motor is configured to rotate the connecting arm around the first pivot joint in a clockwise and anticlockwise direction. A rotation motor may also be arranged in connection with the second pivot joint. The rotation motor is configured to rotate the drive unit around the second pivot joint in a clockwise and anticlockwise direction.

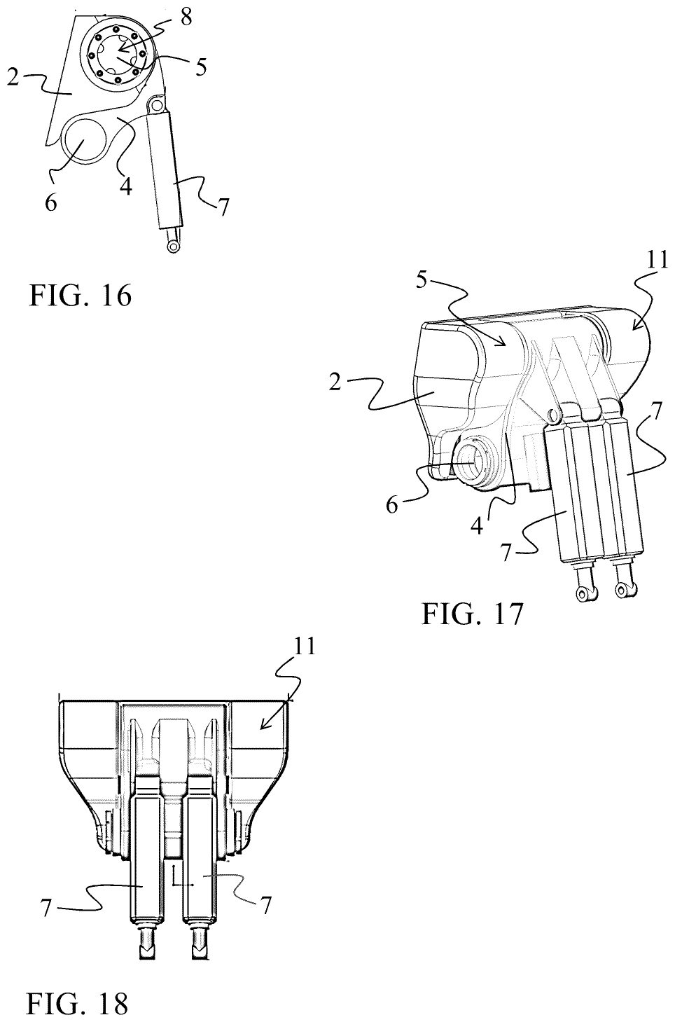

In FIG. 15, another example is shown. A gearing unit 8 is arranged in the first pivot joint 5 and a motor or a step motor 9 is arranged for powering the gearing unit 8. The gearing unit 8 may have different designs and may be a planetary gearing unit. The gearing unit 8 together with the step motor is configured to rotate the connecting arm 4 around the first pivot joint 5 in a clockwise and anticlockwise direction. A gearing unit may also be arranged in the second pivot joint and a motor or a step motor may be arranged for powering the gearing unit. The gearing unit together with the step motor may be configured to rotate the drive unit around the second pivot joint 6 in a clockwise and anticlockwise direction. In FIG. 15, two linear actuators 7 are arranged between the connecting arm 4 and the drive unit for rotating the drive unit around the second pivot joint 6. In FIG. 16, a side view of the gearing unit 8 arranged in connection with the first pivot joint 5 is shown.

In FIGS. 17-18, another example is shown wherein a slew drive 11 is arranged in connection with the first pivot joint 5 for rotating the connecting arm 4 around the first pivot joint 5 in the clockwise and anticlockwise directions. Two linear actuators 7 may be arranged between the connecting arm 4 and the drive unit for rotating the drive unit around the second pivot joint 6.

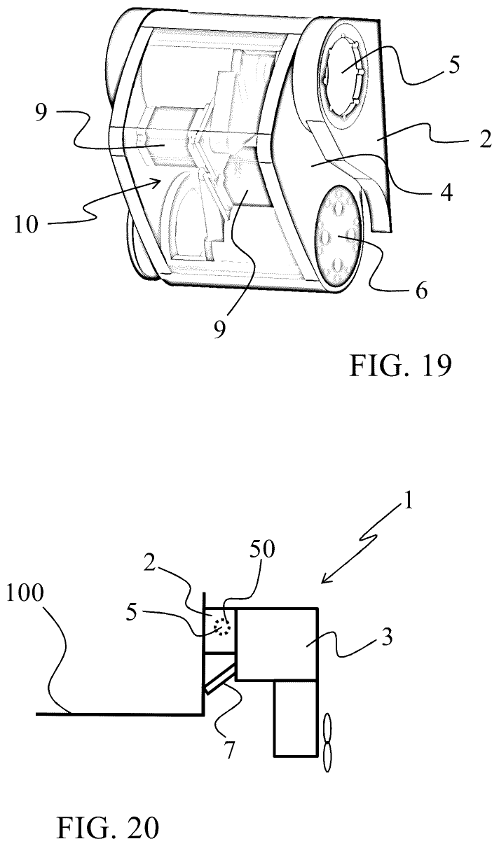

In FIG. 19, another example is shown wherein a double gearing unit or a double planetary gearing unit 10 is arranged with individual step motors 9 in connection with the pivot joints 5, 6.

In another example, the double gearing unit or double planetary gearing unit may be powered by a step motor.

In another example, a hydraulic radial piston motor may be arranged in the second pivot joint.

According to the disclosure, many different combinations of rotating either the first pivot joint and/or the second pivot joint are feasible.

In an example, the drive unit may comprise an electric motor for powering the one or more propellers. In another example, the propulsion system may comprise an engine, a combustion engine, a hydraulic engine or similar for powering the one or more propellers.

The propulsion system may further comprising a kick up function.

The propulsion system may further comprises two or more transom brackets 2 configured to be connected with the transom of the marine vessel, and two or more drive units 3, each drive unit 3 is arranged to be moved in relation to the transom bracket 2 to move the drive unit 3 in the water and out of the water, each drive unit 3 is connected with the transom bracket 2 via a connecting arm 4 having a first pivot joint 5 connected with the transom bracket 2 and a second pivot joint 6 connected with the drive unit 3. In connection with each first pivot joint a brake device is arranged.

In addition, the propulsion system may also comprise the control unit 51 being operatively connected with the drive unit, the first pivot joint, the second pivot joint, the linear actuator, the rotation motor, the electric motor, the hydraulic unit and/or the step motor.

The disclosure also relates to a marine vessel 100 comprising a transom 101 and a propulsion system 1 as described above.

FIG. 20 is another view of the propulsion system 1 according to an example. The propulsion system 1 for a marine vessel 100, comprises a transom bracket 2 being configured to be connected with a transom 101 of the marine vessel. Furthermore, a drive unit 3 being rotatably connected with the transom bracket 2 so as to be pivotable from a lowered position into a raised position, or vice versa, around a pivot joint 5, and an actuator 7 being configured to move the drive unit 3 around the pivot joint 5. Moreover, a brake device 50 is arranged in connection with the pivot joint 5, the brake device 50 is configured to maintain the drive unit 3 in position independently of a state of the actuator 7.

Certain aspects and variants of the disclosure are set forth in the following examples numbered consecutive below.
Example 1: A propulsion system (1) for a marine vessel (100), comprising
a transom bracket (2) being configured to be connected with a transom (101) of the marine vessel (100),
a drive unit (3) being rotatably connected with the transom bracket (2) so as to be pivotable from a lowered position into a raised position, or vice versa, around a pivot joint (5),
an actuator (7) being configured to move the drive unit (3) around the pivot joint (5), wherein a brake device (50) is arranged in connection with the pivot joint (5), the brake device (50) is configured to maintain the drive unit (3) in position independently of a state of the actuator (7).
Example 2: The propulsion system (1) of example 1, further comprising a hydraulic unit (51) and/or a pneumatic unit providing pressure to the actuator (7) and/or to the brake device (50).
Example 3: The propulsion system (1) of example 1 and/or 2, wherein the brake device (50) is configured to maintain the drive unit (3) in position independently of variations of a pressure of the actuator (7).
Example 4: The propulsion system (1) of example 2 and/or 3, wherein the hydraulic unit (51) is configured to provide a predetermined pressure.
Example 5: The propulsion system (1) of example 4, wherein the brake device (50) is configured to lock the pivot joint (5) if the pressure of the actuator (7) is below the predetermined pressure.
Example 6: The propulsion system (1) of example 4, wherein the brake device (50) is configured to unlock the pivot joint (5) when the pressure of the actuator (7) reach the predetermined pressure.
Example 7: The propulsion system (1) of any of the preceding examples, wherein the brake device (50) is configured to be self-controllable and/or is controllable.
Example 8: The propulsion system (1) of any of the preceding examples, wherein the brake device comprises a cone brake unit (50).
Example 9: The propulsion system (1) of example 8, wherein the cone brake unit (50) comprises a cone brake face (60) having a friction enhanced surface or coating.
Example 10: The propulsion system (1) of example 8 and/or 9, wherein the cone brake unit (50) comprises a plurality of compression springs (65) arranged around the cone.
Example 11: The propulsion system (1) of example 10, wherein the plurality of compression springs (65) are configured to provide a predetermined spring force so that the cone brake face (60) is pushed against another face (63) when a pressure drop occurs and/or when the pressure is below the predetermined pressure.
Example 12: The propulsion system (1) of example 10 and/or 11, wherein the compression springs (65) in a first spring end (66) abut a circumferential wall (67), on the opposite side of the circumferential wall a circumferential space (68) is arranged, the circumferential space is in fluid connection with the hydraulic unit (51).
Example 13: The propulsion system (1) of example 12, wherein a valve (52) is arranged between the space and the hydraulic unit.
Example 14: The propulsion system (1) of example 13, wherein the valve (52) is controllable.
Example 15: The propulsion system (1) of example 2, wherein the hydraulic unit (51) is configured to provide pressure to both the actuator and the brake device.
Example 16: The propulsion system (1) of example 2, further comprising a control unit (53) being configured to control the hydraulic unit.
Example 17: The propulsion system (1) of example 16, wherein the control unit (53) is operatively connected with the valve (52).
Example 18: The propulsion system (1) of example 2, further comprising a pressure sensor (54) configured to measure a pressure in the hydraulic unit (51).
Example 19: The propulsion system (1) of example 8, wherein the cone brake unit (50) is arranged in connection with the pivot joint (5).
Example 20: The propulsion system (1) of example 8, wherein the cone brake unit (50) is hollow.
Example 21: The propulsion system (1) of example 8, wherein the cone brake unit (50) and the pivot joint (5) have a common center axis (80).
Example 22: The propulsion system (1) of example 21, wherein the cone brake unit (50) and the pivot joint (5) are hollow along the common center axis (80).
Example 23: The propulsion system (1) of example 22, wherein harnesses, rigging, cables and/or wires is configured to be guided through the hollow pivot joint (5) and cone brake unit (50).
Example 24: The propulsion system (1) of any of the preceding examples, wherein the drive unit (3) has a transportation function, wherein the brake device (50) is activated.
Example 25: The propulsion system (1) of any of the preceding examples, wherein the drive unit (3) has raised position, wherein the brake device (3) is activated.
Example 26: The propulsion system (1) of any of the preceding examples, wherein the actuator (7) is a linear actuator or a rotational actuator.
Example 27: The propulsion system (1) of any of the preceding examples, wherein the actuator (7) comprises a plurality of actuators.
Example 28: The propulsion system (1) of any of the preceding examples, wherein the actuator (7) is a tilt actuator.
Example 29: The propulsion system (1) of any of the preceding examples, further comprising a trim arrangement.
Example 30: The propulsion system (1) of any of the preceding examples, wherein the drive unit (3) comprises an electric motor, an engine, a combustion engine, a hydraulic engine or similar.
Example 31: The propulsion system (1) of example 26, wherein the linear actuator (7) comprises a cylinder and a piston
Example 32: The propulsion system (1) of any of the preceding examples, wherein the drive unit (3) is connected with the transom bracket via a connecting arm (4) having the pivot joint (5) connected with the transom bracket and an additional pivot joint (6) connected with the drive unit (3), wherein the drive unit is configured to be moved in the water and out of the water by the connecting arm pivots around the pivot joint (5) or the drive unit pivots around the additional pivot joint (6) or the connecting arm (4) and the drive unit pivot around both pivot joints (5,6).
Example 33: The propulsion system (1) of example 32, wherein the pivot joint (5) is a first pivot joint (5) and the additional pivot joint (6) is a second pivot joint (6).
Example 34: The propulsion system (1) of example 33, wherein a second brake device (50) is arranged in connection with the second pivot joint (6).
Example 35: The propulsion system (1) of any of the examples 32 to 34, wherein the drive unit (3) is configured to be moved by the connecting arm (4) is pivoted around the first pivot joint (5) in a clockwise direction or an anticlockwise direction independently of any pivoting of the drive unit around the second pivot joint (6).
Example 36: The propulsion system (1) of any of the examples 32 to 35, wherein the drive unit (3) is configured to be moved by the drive unit (3) is pivoted around the second pivot joint (6) in a clockwise direction or an anticlockwise direction independently of any pivoting of the connecting arm (4) around the first pivot joint.
Example 37: The propulsion system (1) of any of the examples 32 to 35, wherein the drive unit (3) is configured to be moved by the connecting arm (4) is pivoted around the first pivot joint (5) in a clockwise direction or an anticlockwise direction at the same time as the drive unit (3) is pivoted around the second pivot joint in a clockwise direction or an anticlockwise direction.
Example 38: The propulsion system (1) of any of the preceding examples, wherein the actuator (7) is a rotation motor is arranged in the first pivot joint (5) and/or in the second pivot joint (6).
Example 39: The propulsion system (1) of example 26, wherein the linear actuator (7) is arranged between the transom bracket (2) and the connecting arm (4), or between the connecting arm (4) and the drive unit (3).
Example 40: The propulsion system (1) of example 26, wherein a plurality of linear actuators are arranged between the transom bracket (2) and the connecting arm (4), or between the connecting arm and the drive unit.
Example 41: The propulsion system (1) of any of the examples 38 to 40, wherein the rotation motor and the linear actuator(s) are configured to pivot the connecting arm (4) around the first pivot joint (5) and/or the drive unit (3) around the second pivot joint (6).
Example 42: The propulsion system (1) of example 38, wherein a motor or a step motor is arranged for powering a gearing unit and/or planetary gearing unit.
Example 43: The propulsion system of example 42, wherein the gearing unit (8) and/or the planetary gearing unit (10) and/or the linear actuator(s) (7) are configured to move the drive unit (3) by pivoting the connecting arm (4) around the first pivot joint (5) and/or by pivoting the drive unit around the second pivot joint (6).
Example 44: The propulsion system (1) of example 33, wherein a slew drive (11) is arranged is arranged in the first pivot joint (5) and/or in the second pivot joint (6).
Example 45: The propulsion system (1) of example 44, wherein the slew drive (11) and/or the linear actuator(s) (7) are configured to move the drive unit (3) by pivoting the connecting arm (4) around the first pivot joint (5) and/or by pivoting the drive unit (3) around the second pivot joint (6).
Example 46: The propulsion system (1) of example 32, wherein a double gearing unit or a planetary gearing unit (10) is arranged with individual step motors in connection with the pivot joints (5,6).
Example 47: The propulsion system (1) of example 32, wherein a double gearing unit or a double planetary gearing unit and a step motor are arranged in connection with the connecting arm (4).
Example 48: The propulsion system (1) of example 33, wherein a hydraulic radial piston motor is arranged in the second pivot joint (6).
Example 49: The propulsion system (1) of example 33, wherein the first pivot joint (5) is arranged at a first end of the connecting arm (4), the second pivot joint (6) is connected at a second end of the connecting arm (4).
Example 50: The propulsion system (1) of example 32, wherein the connecting arm (4) is arranged in a center of the drive unit.
Example 51: The propulsion system (1) of example 32, wherein two connecting arms are arranged between the transom bracket (2) and the drive unit (3).
Example 52: The propulsion system (1) of example 51, wherein the two connecting arms are arranged with a mutual distance between them.
Example 53: The propulsion system (1) of any of the examples 51-52, wherein the two connecting arms have the first pivot joint and the second pivot joint so that the two connecting arms move together around the first pivot joint and/or drive unit pivots around the second pivot joint.
Example 54: The propulsion system (1) of example 32, wherein the connecting arm (4) taper from the first pivot joint towards the second pivot joint.
Example 55: The propulsion system (1) of example 32, wherein the linear actuator (7) has an actuator end, the actuator end being connected with the connecting arm (4).
Example 56: The propulsion system (1) of example 32, wherein the linear actuator (7) is connected with the drive unit (3) and the connecting arm (4) or the transom bracket and the connecting arm.
Example 57: The propulsion system (1) of example 32, wherein the linear actuator (7) is connected with the drive unit (3) in a distance below the second pivot joint.
Example 58: The propulsion system (1) of example 57, wherein the linear actuator (7) is connected with the drive unit (3) via a drive pivot joint (12).
Example 59: The propulsion system (1) of example 33, wherein the drive unit (3) is configured to be trimmed and/or titled around the first pivot joint (5) and/or the second pivot joint (6).
Example 60: The propulsion system (1) of any of the preceding examples, wherein the drive unit (3) comprises one or more propellers 13a, 13b).
Example 61: The propulsion system (1) of example 60, wherein the one or more propellers (13a, 13b) are configured to push the marine vessel (100) in a forward motion of the marine vessel.
Example 62: The propulsion system (1) of example 60, wherein the one or more propellers (13a, 13b) are configured to pull the marine vessel in a forward motion of the marine vessel.
Example 63: The propulsion system (1) of any of the examples 60-62, wherein the drive unit (3) comprises a first propeller (13a) and a second propeller (13b).
Example 64: The propulsion system (1) of example 63, wherein the first propeller (13a) is arranged to be counter-rotating compared to the second propeller (13b).
Example 65: The propulsion system (1) of any of the examples 60-64, wherein the one or more propellers (13a, 13b) comprises an angle of thrust.
Example 66: The propulsion system (1) of example 32, further comprises one or more transom brackets (2) configured to be connected with the transom of the marine vessel, and one or more drive units (3),
each drive unit is arranged to be moved in relation to the transom bracket (2) to move the drive unit (3) in the water and out of the water,
each drive unit is connected with the transom bracket via a connecting arm (4) having a first pivot joint connected with the transom bracket and a second pivot joint connected with the drive unit.
Example 67: The propulsion system (1) of example 16, wherein the control unit (53) being operatively connected with the drive unit, the first pivot joint, the second pivot joint, the linear actuator, the rotation motor, the electric motor, the hydraulic system and/or the step motor.
Example 68: A marine vessel (100) comprising a transom (101) and a propulsion system (1) of any of the preceding examples.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A propulsion system for a marine vessel, comprising
a transom bracket being configured to be connected with a transom of the marine vessel, a drive unit being rotatably connected with the transom bracket so as to be pivotable from a lowered position into a raised position, or vice versa, around a pivot joint,
an actuator being configured to move the drive unit around the pivot joint,
wherein a brake device is arranged in connection with the pivot joint, the brake device is configured to maintain the drive unit in position independently of a state of the actuator.

2. The propulsion system of claim 1, further comprising a hydraulic unit and/or a pneumatic unit providing pressure to the actuator and/or to the brake device.

3. The propulsion system of claim 1, wherein the brake device is configured to maintain the drive unit in position independently of variations of a pressure of the actuator.

4. The propulsion system of claim 2, wherein the hydraulic unit and/or a pneumatic unit is configured to provide a predetermined pressure.

5. The propulsion system of claim 4, wherein the brake device is configured to lock the pivot joint if the pressure of the actuator is below the predetermined pressure.

6. The propulsion system of claim 4, wherein the brake device is configured to unlock the pivot joint when the pressure of the actuator reaches the predetermined pressure.

7. The propulsion system of claim 1, wherein the brake device comprises a cone brake unit.

8. The propulsion system of claim 7, wherein the cone brake unit comprises a cone brake face having a friction enhanced surface or coating.

9. The propulsion system of claim 7, wherein the cone brake unit comprises a plurality of compression springs arranged around the cone.

10. The propulsion system of claim 9, wherein the plurality of compression springs are configured to provide a predetermined spring force so that the cone brake face is pushed against another face when a pressure drop occurs and/or when the pressure is below a predetermined pressure.

11. The propulsion system of claim 9, wherein the compression springs in a first spring end abut a circumferential wall, on the opposite side of the circumferential wall a circumferential space is arranged, the circumferential space is in fluid connection with the hydraulic unit.

12. The propulsion system of claim 7, wherein the cone brake unit is arranged in connection with the pivot joint.

13. The propulsion system of claim 7, wherein the cone brake unit is hollow.

14. The propulsion system of claim 11, wherein a valve is arranged between the space and the hydraulic unit.

15. The propulsion system of claim 2, further comprising a control unit being configured to control the hydraulic unit.

16. The propulsion system of claim 1, wherein the drive unit has a transportation function, wherein the brake device is activated.

17. The propulsion system of claim 1, wherein the actuator is a linear actuator or a rotational actuator.

18. The propulsion system of claim 1, wherein the drive unit is connected with the transom bracket via a connecting arm having the pivot joint connected with the transom bracket and an additional pivot joint connected with the drive unit,
wherein the drive unit is configured to be moved in the water and out of the water by the connecting arm pivots around the pivot joint or the drive unit pivots around the additional pivot joint or the connecting arm and the drive unit pivot around both pivot joints,
wherein the pivot joint is a first pivot joint and the additional pivot joint is a second pivot joint.

19. The propulsion system of claim 18, wherein a second brake device is arranged in connection with the second pivot joint.

20. A marine vessel comprising a transom and a propulsion system of claim 1.
